(19) United States
(12) Patent Application Publication
(10) Pub. No.: US 2023/0226498 A1
(43) Pub. Date: Jul. 20, 2023

(54) FLAT CERAMIC MEMBRANE

(71) Applicant: MEIDENSHA CORPORATION, Shinagawa-ku, Tokyo (JP)

(72) Inventor: Toru TSUCHIYA, Nagoya-shi, Aichi (JP)

(73) Assignee: MEIDENSHA CORPORATION, Shinagawa-ku, Tokyo (JP)

(21) Appl. No.: 18/022,126

(22) PCT Filed: Jul. 27, 2021
(86) PCT No.: PCT/JP2021/027652

§ 371 Date: Feb. 17, 2023

(30) Foreign Application Priority Data
Aug. 21, 2020 (JP) 2020-139729

(51) Int. Cl. B01D 69/10; B01D 71/02; B01D 69/06

(52) U.S. Cl. CPC B01D 69/108; B01D 69/06; B01D 71/024

(57) ABSTRACT

A flat ceramic membrane 1 has a plate-shaped porous support 21 made of ceramics and a filtration membrane 22 formed on an outer surface of the porous support 21. A plurality of water collection channels 2 where filtrate water obtained by permeation of water-to-be-treated through the filtration membrane 22 flows are formed inside the porous support 21. Further, a region where a distance between the water collection channels 2 is different is ensured inside the porous support 21.

### TECHNICAL FIELD

The present invention relates to a structure of a flat-shaped ceramic membrane (hereinafter, referred to as a flat ceramic membrane) applied to water treatment.

### BACKGROUND ART

A flat ceramic membrane is used in a process of solid-liquid separation in the water treatment (Patent Document 1 etc.). For instance, when performing suction by a pump etc. from a drain side of a flat ceramic membrane 1 immersed in water-to-be-treated 11 indicated by arrows in FIG. 15, the water-to-be-treated 11 permeates through the flat ceramic membrane 1 from a membrane surface to water collection channels 2 that are water collection passages inside the membrane. Then, filtrate water 12 indicated by arrows in the same drawing, which is obtained by the permeation, is transferred from one end sides of the water collection channels 2 to the outside of a system by the suction. In addition, in an operation of the flat ceramic membrane 1, by making the filtrate water 12 flow back from the water collection channel 2 side toward the membrane surface side at the appropriate times, clogging of the membrane surface is eliminated and suppressed. Further, as illustrated in FIG. 16A, by continuously or intermittently supplying air 13 for cleaning the membrane from a lower side of the flat ceramic membrane 1, shear forces in arrow directions along a supply direction of the air 13 which are distributed in a parabolic shape that becomes a maximum in the middle are generated on the membrane surface, thereby eliminating the clogging.

### CITATION LIST

### Patent Document

Patent Document 1: Japanese Unexamined Patent Application Publication No. 2014-028331
Patent Document 2: Japanese Unexamined Patent Application Publication No. 2015-112527

### SUMMARY OF THE INVENTION

In the operation of the flat ceramic membrane 1, by the supply of the air 13 to the membrane surface, i.e. by so-called air diffusion to the membrane surface, the clogging of the membrane surface is eliminated and suppressed. However, in terms of power consumption, minimization of a supply amount of the air 13 is required. In order to generate the shear force required for the cleaning of the flat ceramic membrane 1, a predetermined supply amount of the air is necessary.

If the supply amount of the air 13 is reduced, although the shear force generated at the flat ceramic membrane 1 along the supply direction of the air 13 becomes a maximum in the middle, the shear force generated along the supply direction of the air 13 becomes a minimum at end portion sides (see FIG. 16B), and a difference in cleaning effect between the middle and the end portion side is considerable. Because of this, stable water treatment becomes difficult.

Further, although a ceramic base material forming the flat ceramic membrane 1 is physically and chemically stable, since it is classified as a brittle material, when stress exceeding an allowance (a permissible value) of a mechanical strength of the base material occurs due to unexpected situations such as misoperation of machines or facilities and natural disaster, there is a risk that the ceramic base material will be broken.

The present invention was made in view of the above circumstances, and an object of the present invention is to increase the mechanical strength of the flat ceramic membrane and stabilize the water treatment.

As one aspect of the present invention, a flat ceramic membrane comprises: a plate-shaped porous support made of ceramics; and a filtration membrane formed on an outer surface of the porous support, wherein inside the porous support, a plurality of water collection passages where filtrate water obtained by permeation of water-to-be-treated through the filtration membrane flows are formed, and a region where a distance between the water collection passages is different is ensured.

As one aspect of the present invention, adistance between the water collection passages, which are along a supply direction of air for membrane cleaning, in a region that is located in a vicinity of an end portion is greater than a distance between the water collection passages in a region that is a region other than the vicinity of the end portion.

As one aspect of the present invention, a distance between the water collection passages, which are along the supply direction, at a middle portion is greater than the other distance between the water collection passages in the region other than the vicinity of the end portion.

As one aspect of the present invention, a cross section of the water collection passage in the region located in the vicinity of the end portion is smaller than a cross section of the water collection passage in the region other than the vicinity of the end portion.

As one aspect of the present invention, a drain portion for draining the filtrate water supplied from one end openings of the water collection passages is fixed to one end portion of the porous support.

According to the present invention, it is possible to increase the mechanical strength of the flat ceramic membrane and stabilize the water treatment.

### BRIEF DESCRIPTION OF THE DRAWINGS

FIG. 1 is a sectional view of a flat ceramic membrane according to an embodiment 1 as one aspect of the present invention.

FIG. 2 is a sectional view showing a deposition state (an accumulation state or an adhesion state) of deposit on a membrane surface of the embodiment 1.

FIG. 3 is a sectional view of a flat ceramic membrane according to an embodiment 2 as one aspect of the present invention.

FIG. 4 is a sectional view showing a deposition state (an accumulation state or an adhesion state) of deposit on a membrane surface of the embodiment 2.

FIG. 5 is a sectional view of a flat ceramic membrane according to an embodiment 3 as one aspect of the present invention.

FIG. 6 is a sectional view showing a deposition state (an accumulation state or an adhesion state) of deposit on a membrane surface of the embodiment 3.

FIG. 7 is a sectional view showing an osmosis state (an infiltration state or a permeation state) of a backwash agent inside the membrane of the embodiment 2.

FIG. 8 is a sectional view of a flat ceramic membrane according to an embodiment 4 as one aspect of the present invention.

FIG. 9 is an explanatory drawing showing a relationship between a thickness between a membrane surface and a water collection channel and a flow velocity of filtrate water.

FIG. 10 is a sectional view of the flat ceramic membrane for explaining working and effect of the embodiment 4.

FIG. 11A is a sectional view of the flat ceramic membrane for explaining working and effect of the embodiment 4 when performing backwash. FIG. 11B is a sectional view showing an osmosis state (an infiltration state or a permeation state) of the backwash agent inside the membrane of the embodiment 4.

FIG. 12 is a sectional view of a flat ceramic membrane according to an embodiment 5 as one aspect of the present invention.

FIG. 13 is a sectional view of a flat ceramic membrane according to an embodiment 6 as one aspect of the present invention.

FIG. 14 is characteristics showing variation of a membrane pressure difference with time of the embodiments of the present invention and a comparative example.

FIG. 15 is a perspective view showing an internal structure of the flat ceramic membrane.

FIG. 16A is a distribution diagram of a shear force generated at the flat ceramic membrane by a normal cleaning air amount. FIG. 16B is a distribution diagram of a shear force generated at the flat ceramic membrane by a cleaning air amount that is smaller than the normal cleaning air amount.

### EMBODIMENTS FOR CARRYING OUT THE INVENTION

Embodiments of the present invention will be described below with reference to the drawings.

### Embodiment 1

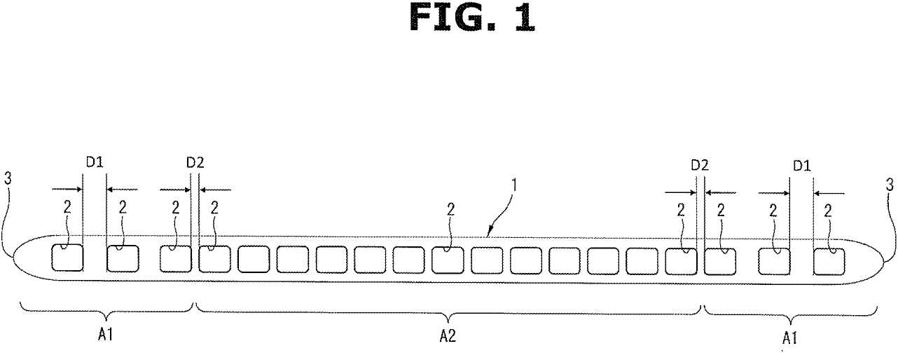

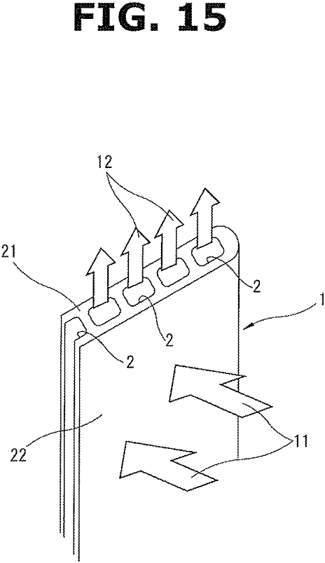

A flat ceramic membrane 1 of an embodiment 1 shown in FIG. 1 has, as illustrated in FIG. 15, a plate-shaped (e.g. long plate-shaped) porous support 21 made of ceramics and a filtration membrane 22 formed on an outer surface of the porous support 21.

A base material of the porous support 21 is made of metal oxide (metallic oxide). For instance, alumina, silica, titania and zirconia or mixture of these materials are applied (Patent Document 2).

Inorganic material forming the filtration membrane 22 is a porous complex of a base material and a modifier. As the base material, for instance, alumina is preferable, and as the modifier, for instance, titania is preferable (Patent Document 2).

Inside the porous support 21, as water collection passages where filtrate water 12 obtained by permeation of water-to-be-treated 11 through the filtration membrane 22 flows, a plurality of water collection channels 2 are formed parallel to each other. Further, inside the porous support 21, at least two regions where a distance between the water collection channels 2 is different from the others are ensured.

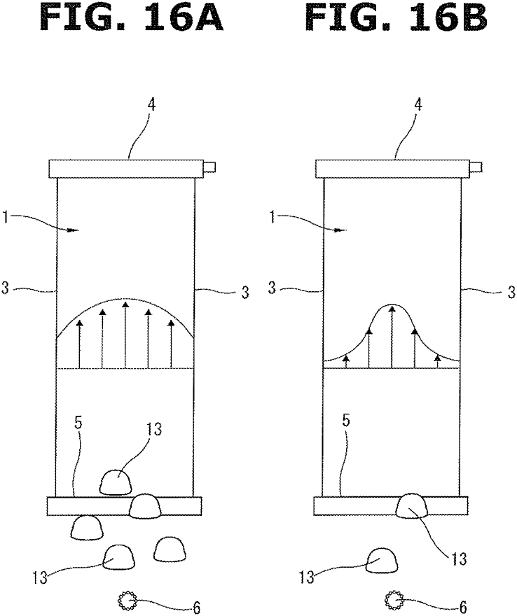

In particular, in a case of the flat ceramic membrane 1 of FIG. 1, a distance D1 between the water collection channels 2, which are along a supply direction (FIGS. 16A and 16B) of air 13 for the membrane cleaning, in each region A1 (a region where supply of the air 13 is relatively small) that is located in the vicinity of an end portion 3 is set to be greater than a distance D2 between the water collection channels 2 in a region A2 (a region where supply of the air 13 is relatively large) that is a region other than the vicinity of the end portion 3.

Further, as illustrated in FIGS. 16A and 16B, a header 4 as a drain portion for draining the filtrate water 12 supplied from one end openings of the water collection channels 2 is liquid-tightly fixed to at least one end portion in a longitudinal direction of the flat ceramic membrane 1. On the other hand, a footer 5 as a sealing portion for sealing the other end openings of the water collection channels 2 is liquid-tightly fixed to the other end portion in the longitudinal direction of the flat ceramic membrane 1. It is noted that the headers 4 could be provided at both end portions in the longitudinal direction of the flat ceramic membrane 1, then the filtrate water 12 is drained from both these end portions.

Working and effect of the flat ceramic membrane 1 of the present embodiment will be described with reference to FIGS. 1, 2, 15, 16A and 16B.

When the water-to-be-treated 11 of FIG. 15 is subjected to solid-liquid separation on a membrane surface 20 of the flat ceramic membrane 1 by suction by a pump etc., the water-to-be-treated 11 permeates through the filtration membrane 22, and the filtrate water 12 can be obtained in the water collection channels 2. The filtrate water 12 is then drained from the header 4 of the flat ceramic membrane 1 to the outside of the system.

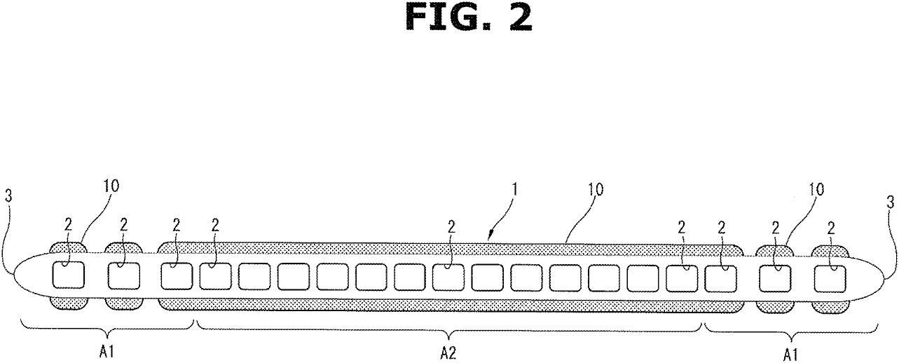

On the other hand, a solid component such as sludge contained in the water-to-be-treated 11 of FIGS. 16A and 16B is deposited on the surface of the flat ceramic membrane 1 corresponding to the water collection channels 2 shown in FIG. 2. Then, deposit 10 of this solid component of the flat ceramic membrane 1 is removed by a shear force of bubbles by the air 13 for the membrane cleaning which is supplied from an air diffuser pipe 6 arranged below the flat ceramic membrane 1 shown in FIGS. 16A and 16B.

As described above, the shear force in the region A1 of the flat ceramic membrane 1 is weak as compared with the shear force in the region A2 (FIGS. 16A and 16B). On the other hand, in the case of the flat ceramic membrane 1 of the present embodiment, since the distance D1 between the water collection channels 2 in the region A1 is set to be greater than the distance D2 between the water collection channels 2 in the region A2, a deposition amount of the solid component in the region A1 is smaller than a deposition amount of the solid component in the region A2 (FIG. 2). Therefore, the deposit 10 in the region A1 can be removed by the shear force by the bubbles which is smaller than the shear force in the region A2. It is thus possible to remove the deposit 10 uniformly throughout the entire flat ceramic membrane 1.

Further, since the region A1 where the distance D1 is ensured is a region where there is a few deposit 10, bubbles of the air 13 tend to enter between the flat ceramic membrane 1 and the deposit 10, and thus a cleaning effect in the region A1 is increased.

When a crack occurs due to an excessive load on the flat ceramic membrane 1, stress concentration in the region A1 becomes an origin (a starting point) of the crack. Since the flat ceramic membrane 1 is formed so that the distance D1 between the water collection channels 2 in the region A1 is set to be greater than the distance D2 between the water collection channels 2 in the region A2, an amount of the ceramic base material in the region A1 is relatively high. This leads to an increase in the mechanical strength of the flat ceramic membrane 1.

### Embodiment 2

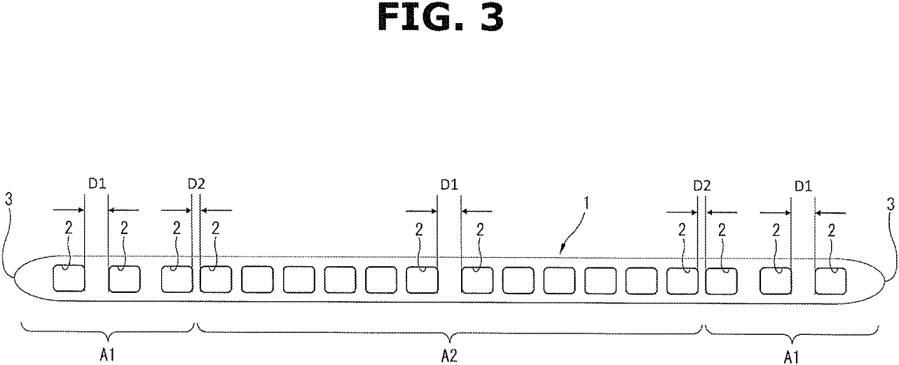

A flat ceramic membrane 1 of an embodiment 2 shown in FIG. 3 is the same as that of the embodiment 1 except that a distance D1 between the water collection channels 2, which are along the supply direction of the air 13 for the membrane cleaning, at a middle portion C in the region A2 is set to be greater than the other distance D2 between the water collection channels 2 in the region A2.

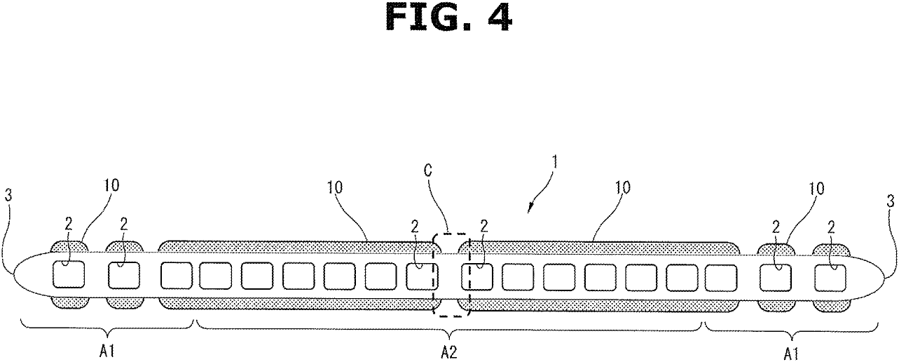

According to the above flat ceramic membrane 1, since the distance D1 between the water collection channels 2 at the middle portion C is set to be greater than the other distance D2 between the water collection channels 2 in the region A2, as shown in FIG. 4, a point as the origin of exfoliation (separation or delamination) of the deposit is formed at the middle portion C. Therefore, in addition to the effect of the embodiment 1, stable solid-liquid separation can be performed over an extended time period. Moreover, since a portion (the middle portion C) of the ceramic base material of the flat ceramic membrane 1 where the shear force by the air 13 becomes a maximum is reinforced, the mechanical strength of the entire flat ceramic membrane 1 is further increased.

### Embodiment 3

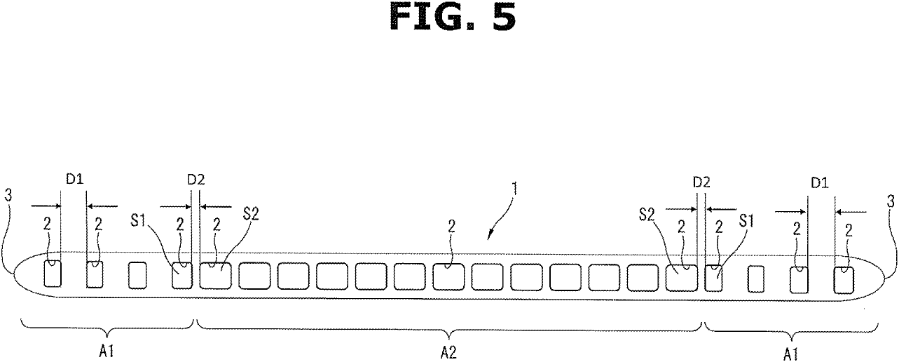

A flat ceramic membrane 1 of an embodiment 3 shown in FIG. 5 is the same as that of the embodiment 1 except that a cross section S1 of the water collection channel 2 in the region A1 is smaller than a cross section S2 of the water collection channel 2 in the region A2.

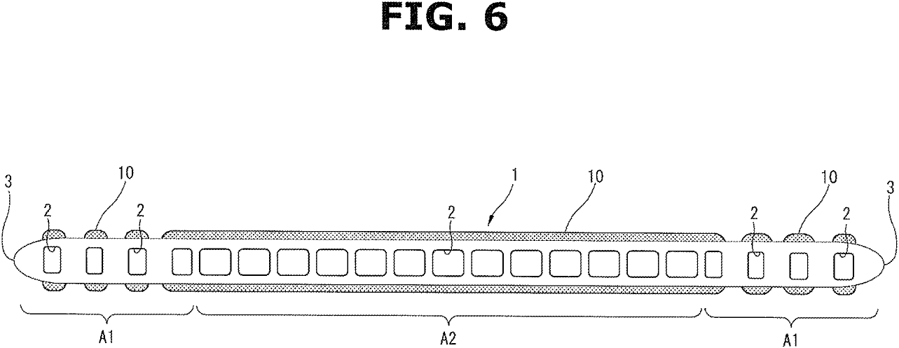

According to the above flat ceramic membrane 1, the same working and effect as those of the embodiment 1 can be obtained. In particular, since an amount of the ceramic base material at a portion in the vicinity of the end portion 3 is increased, the mechanical strength of the flat ceramic membrane 1 is further increased (FIG. 6).

Here, if the cross sections S1 and S2 of the water collection channel 2 of the present embodiment are applied to the flat ceramic membrane 1 of the embodiment 2, it is possible to increase the mechanical strength of this flat ceramic membrane 1.

### Embodiment 4

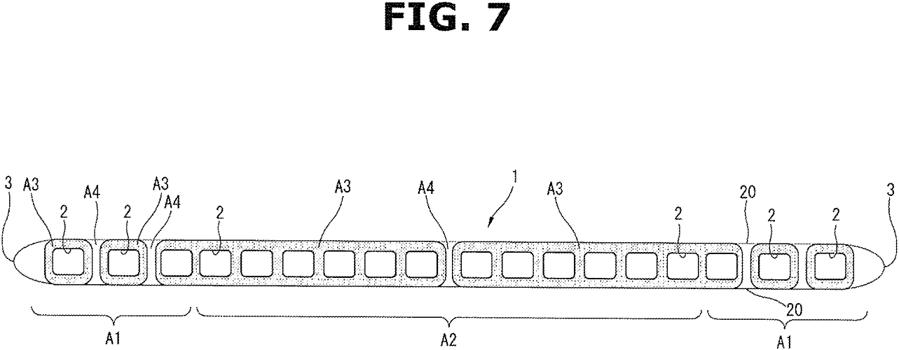

Substances adhering to an inside of the membrane and the surface of the flat ceramic membrane 1, which cause membrane clogging, are chemically removed by a cleaning method (chemical backwash) in which a chemical solution such as sodium hypochlorite is fed from the water collection channel 2 side to the membrane surface. At this time, for instance, at the inside of the flat ceramic membrane 1 of the embodiment 2 shown in FIG. 7, a penetrating portion A3 of the chemical solution and a non-penetrating portion A4 of the chemical solution appear. The non-penetrating portion A4 may cause biofilm growth which leads to the membrane clogging, then may result in a decrease in filtration efficiency.

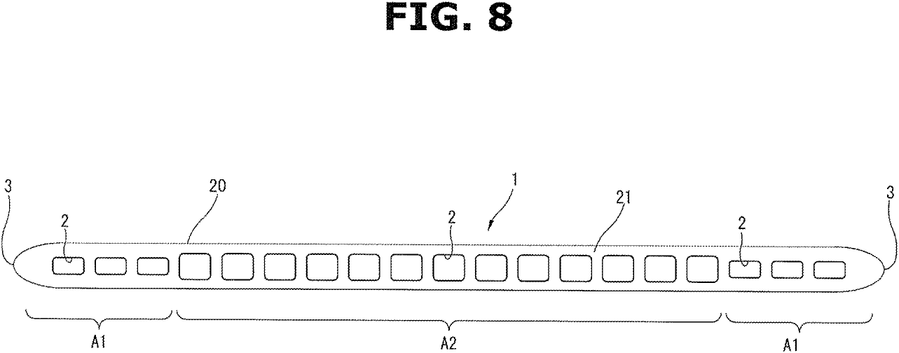

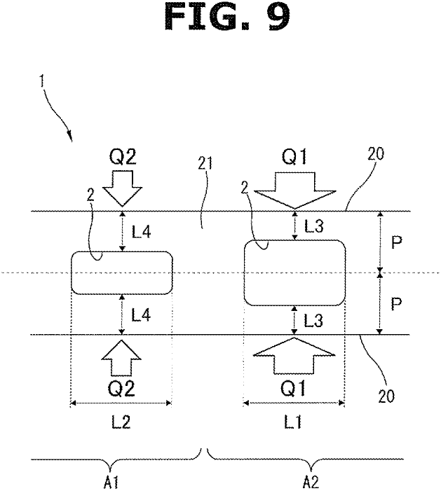

Therefore, in a case of a flat ceramic membrane 1 of an embodiment 4 shown in FIGS. 8 and 9, a region where a thickness between the membrane surface 20 and the water collection channel 2 is different is ensured at the flat ceramic membrane 1 to which the chemical backwash is applied, thereby achieving high flux and increasing the mechanical strength of the flat ceramic membrane 1.

The flat ceramic membrane 1 shown in FIG. 9 is the same as that of the embodiment 1 except that while the water collection channels 2 are arranged at regular intervals, a thickness L4 between the membrane surface 20 and the water collection channel 2 in the region A1 is set to be greater than a thickness L3 between the membrane surface 20 and the water collection channel 2 in the region A2. On the other hand, inside diameters L2 and L1, along the membrane surface 20, of the water collection channels 2 in the regions A1 and A2 are set to the same size.

Although it is desirable that the water collection channels 2 be formed at regular intervals, depending on a usage condition etc., in the same manner as the embodiment 1, the distance D1 between the water collection channels 2 in the region A1 could be set to be greater than the distance D2 between the water collection channels 2 in the region A2 that is the region other than the end portion 3 side.

Working and effect of the flat ceramic membrane 1 of the present embodiment will be described with reference to FIGS. 8 to 11.

As illustrated in FIG. 9, a pressure difference P that is a driving force of the filtration generated by the suction pump etc. is uniform regardless of a shape and a size of the water collection channel 2. On the other hand, a resistance R of filtration permeation is different depending on a distance between the membrane surface and the water collection channel 2. Because of this, in a case where the inside diameter of the water collection channel 2 is small and the thickness between the membrane surface 20 and the water collection channel 2 is great, a flow velocity Q of the filtrate water becomes low. For the water collection channels 2 in the regions A1 and A2 in FIG. 9, when the inside diameter L2 is equal to the inside diameter L1 (the inside diameter L2 = equal to the inside diameter L1) and the thickness L4 is greater than the thickness L3 (the thickness L4 > the thickness L3), a flow velocity Q1 is higher than a flow velocity Q2 (a flow velocity Q1 > a flow velocity Q2). The flow velocity Q1 indicates a flow velocity of the filtrate water between the membrane surface 20 of the thickness L3 and the water collection channel 2. The flow velocity Q2 indicates a flow velocity of the filtrate water between the membrane surface 20 of the thickness L4 and the water collection channel 2. That is, a degree of the clogging (or blockage) of the flat ceramic membrane 1 is affected by the shape of the water collection channel 2.

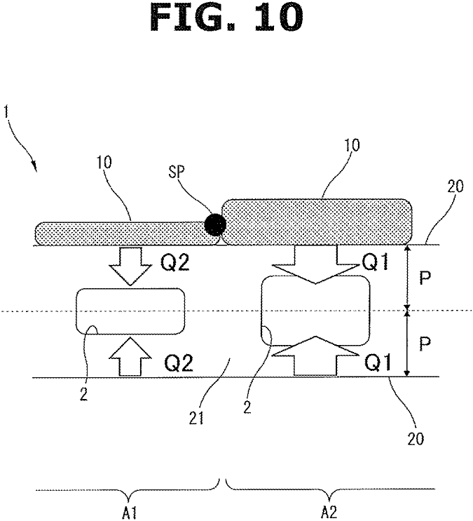

According to the above flat ceramic membrane 1, since the thickness L4 between the membrane surface 20 and the water collection channel 2 in the region A1 is greater than the thickness L3 between the membrane surface 20 and the water collection channel 2 in the region A2, there arises a difference in a treatment amount between the region A1 and the region A2. As illustrated in FIG. 10, although more clogging substances are deposited in the region A2 of the flat ceramic membrane 1 where a large amount of water-to-be-treated is supplied, since the cleaning effect by the air diffusion is high, stable filtration can be continued. In particular, since the difference in thickness of the deposit 10 arises between the region A1 and the region A2, as shown in FIG. 10, a step portion of the deposit 10 becomes an origin (a starting point) SP of the exfoliation (the separation or the delamination) by the bubbles, thereby improving filtration efficiency as compared with a conventional flat ceramic membrane.

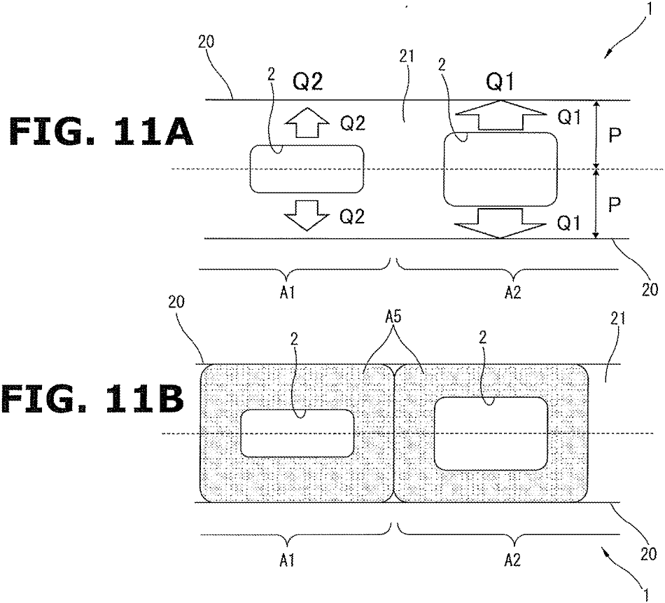

During the backwash, as illustrated in FIG. 11A, since a flow velocity Q1 of backwash liquid between the water collection channel 2 and the membrane surface 20 in the region A2 is greater than a flow velocity Q2 of backwash liquid between the water collection channel 2 and the membrane surface 20 in the region A1, effect of the backwash is increased. At this time, film-like clogging substances are peeled off (delaminated or exfoliated) then removed with the locally existing large water collection channel 2 being the origin (the starting point). Further, during the chemical backwash, as illustrated in FIG. 11B, since the backwash liquid or the chemical solution permeates through a peripheral region A5 of the water collection channel 2 and soaks through the entire flat ceramic membrane 1, the cleaning effect is increased.

In addition, when switching between the filtration and the backwash, due to malfunction of a device or incorrect procedure, there may occur a water hammer phenomenon in which pressure in a pipe transiently rises or falls by a sudden change in the flow velocity. When this phenomenon occurs, pressure is applied to the flat ceramic membrane 1, and at the same time, vibrations occur, which may cause breakage of the flat ceramic membrane 1 depending on a degree of generated load.

In contrast to this, in the case of the flat ceramic membrane 1 of the present embodiment, since the region where the thickness between the membrane surface 20 and the water collection channel 2 is different is formed, the porous support 21 has a partial thickness inside the porous support 21. With this, the mechanical strength of the flat ceramic membrane 1 is increased, thereby preventing the breakage of the flat ceramic membrane 1 caused by the water hammer phenomenon.

According to the embodiment 4, efficiency of the air diffusion cleaning (air cleaning) and the back pressure cleaning (the backwash, the chemical backwash) of the flat ceramic membrane 1 can be increased. Therefore, the substances causing the membrane clogging are efficiently removed, and high flux can be achieved.

### Embodiment 5

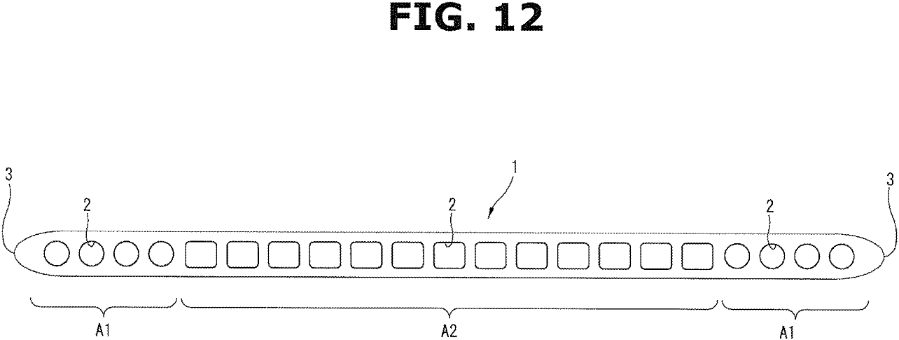

A flat ceramic membrane 1 of an embodiment 5 shown in FIG. 12 is the same as that of the embodiment 4 except that a shape of a cross section of the water collection channel 2 in the region A1 is a circle.

According to the present embodiment, since a cross-sectional area of the water collection channel 2 in the region A1 is smaller than a cross-sectional area of the water collection channel 2 in the region A2, it is obvious that the same working and effect as those of the embodiment 4 can be obtained. In particular, since the water collection channel 2 in the regional A1 is circular, the mechanical strength of the region A1 is increased, and the flat ceramic membrane 1 that is resistant to external load can be obtained.

### Embodiment 6

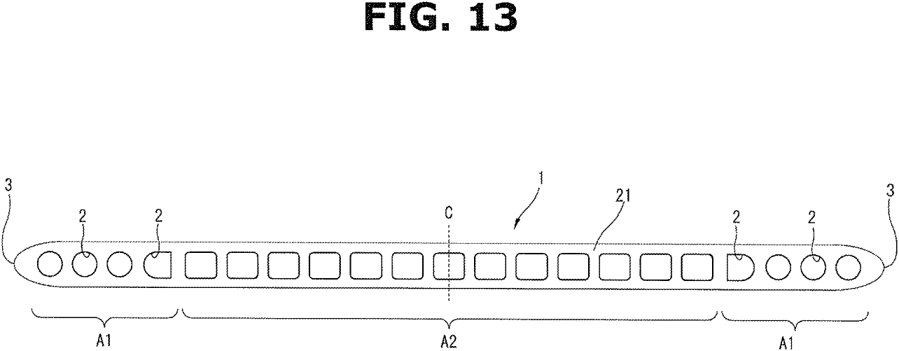

A flat ceramic membrane 1 shown in FIG. 13 is the same as that of the embodiment 5 except that a cross section of the water collection channel 2, which is along the supply direction of the air for the membrane cleaning, is formed so as to be smaller from the middle portion C of the flat ceramic membrane 1 (the porous support 21) as it approaches the end portion. For instance, as illustrated in FIG. 13, a cross section of the water collection channel 2 which is located close to the region A2 in region A1 has an asymmetrical shape (e.g. a D-shaped cross section which is smaller than a substantially rectangular cross section of the water collection channel 2 of the region A2) with respect to a thickness direction of the flat ceramic membrane 1.

According to the present embodiment, the same working and effect as those of the embodiments 4 and 5 can be obtained. In addition, it is possible to adjust an amount of water collected in the water collection channels 2 according to a diffusion air amount, thereby performing the filtration more efficiently.

### The Embodiments

Table 1 shows mechanical strengths of the flat ceramic membranes 1 of the embodiments 1 to 3 with respect to a mechanical strength of a conventional flat ceramic membrane as a comparative example. For comparison of the mechanical strength, a value of a local load which leads to the breakage of the flat ceramic membrane was compared.

TABLE 1

| Sample | Strength (-) |
|---|---|
| Comparative Example | 100 |
| Embodiment 1 | 113 |
| Embodiment 2 | 115 |
| Embodiment 3 | 139 |

As is clear from a result of Table 1, the embodiments 1 to 3 provide higher mechanical strengths than that of the comparative example. In particular, it is found that the mechanical strength is further increased by the embodiment 3.

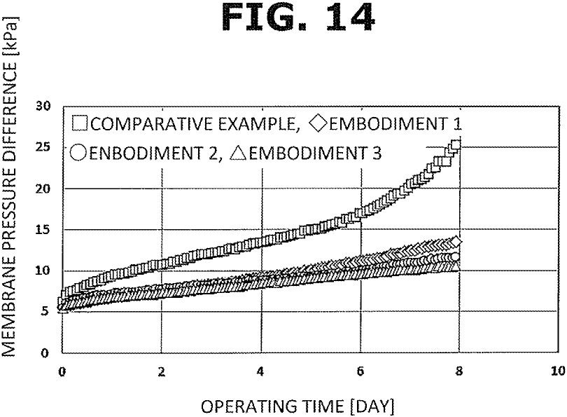

Further, FIG. 14 shows variation of a membrane pressure difference with time of the embodiments 1 to 3 and the comparative example.

In the embodiments 1 to 3 and the comparative example, a filtration flux was set to 1.27 m/day, a backwash flow velocity was set to twice that of the velocity at the time of the filtration, a diffusion air amount was set to ten times that of the amount at the time of the filtration, and an operation cycle was set so that a filtration time was 9.5 minutes and a backwash time was 0.5 minutes. Further, a net operating flux including return of the filtrate water by the backwash was 1.08 m/day.

According to the variation of the membrane pressure difference with time shown in FIG. 14, it is found that the membrane pressure difference of the comparative example significantly increases with time from an initial time, whereas variations of the membrane pressure differences of the embodiments 1 to 3 are a small increase from the initial time. From this, long-term stabilization of the water treatment by the solid-liquid separation using the flat ceramic membrane can be realized by the embodiments 1 to 3.

According to the flat ceramic membranes 1 of the embodiments 1 to 3, it is possible to decrease the amount of the deposit 10 of the solid component in the region A1 more than the region A2, then the cleaning effect of the surface of the flat ceramic membrane 1 by the air diffusion is increased. In particular, the membrane clogging (the membrane blockage) around the end portion 3 of the flat ceramic membrane 1 extending along the supply direction of the air 13 for the membrane cleaning can be prevented. Further, the mechanical strength of the region A1 (in the case of the embodiment 2, the region A1 and the middle portion C) of the flat ceramic membrane 1 is increased (Table 1), thereby reducing risk of the breakage of the flat ceramic membrane 1 due to unexpected situations such as misoperation of machines or facilities and natural disaster.

1-5. (canceled)

6. A flat ceramic membrane comprising:
a plate-shaped porous support made of ceramics; and
a filtration membrane formed on an outer surface of the porous support, wherein
inside the porous support, a plurality of water collection passages where filtrate water obtained by permeation of water-to-be-treated through the filtration membrane flows are formed, and a region where a distance between the water collection passages is different is ensured, and
a distance between the water collection passages, which are along a supply direction of air for membrane cleaning, in a region that is located in a vicinity of an end portion is greater than a distance between the water collection passages in a region that is a region other than the vicinity of the end portion.

7. The flat ceramic membrane as claimed in claim 6, wherein
a distance between the water collection passages, which are along the supply direction, at a middle portion is greater than the other distance between the water collection passages in the region other than the vicinity of the end portion.

8. The flat ceramic membrane as claimed in claim 6, wherein
a cross section of the water collection passage in the region located in the vicinity of the end portion is smaller than a cross section of the water collection passage in the region other than the vicinity of the end portion.

9. The flat ceramic membrane as claimed in claim 6, wherein
a drain portion for draining the filtrate water supplied from one end openings of the water collection passages is fixed to one end portion of the porous support.
